(19) United States
(12) Patent Application Publication
(10) Pub. No.: US 2004/0192253 A1
(43) Pub. Date: Sep. 30, 2004

(54) Content delivery system

(76) Inventor: Motoharu Usumi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/771,937

(22) Filed: Feb. 4, 2004

(30) Foreign Application Priority Data
Mar. 28, 2003 (JP) 2003-91425(PAT.

(51) Int. Cl. H04M 11/00

(52) U.S. Cl. 455/406

(57) ABSTRACT

The invention relates to an information delivery system and, more particularly, to the provision of a content delivery system that properly bills a user when delivering content such as music and moving images to the user by means of streaming over the Internet. The system for delivering the content over the network comprises: a subscriber serving apparatus serving the user; a delivery server for delivering the content; and a billing server for billing for the delivery of the content, wherein the subscriber serving apparatus includes monitoring means for monitoring the data stream being delivered from the delivery server to the user, and the billing server includes judging means for judging whether to bill or not bill the user based on the delivery quality of the monitored data stream, and bills the user based on the result of the judgment made by the judging means.

### BACKGROUND OF THE INVENTION

1. Field of the Invention

The present invention relates to an information delivery system and, more particularly, to a content delivery system that delivers time-sensitive content data such as music and moving images to listeners or viewers by means of streaming over the Internet, and collects charges from the listeners or viewers (hereinafter generally called the “user”) who subscribe to the service.

2. Description of the Related Art

With the proliferation of broadband Internet services in recent years, not only delivery of conventional content such as text and images but also delivery of so-called rich content such as music and moving images has been increasing rapidly. There are many services that offer content for a fee and charge a small fee to the user for use of the content.

Many of such services require that the user settle the payment before watching or listening to the content, and many of the services employ streaming delivery technology in which the content data is discarded after it has been played on the user terminal, in order to prevent illegal copying or other illegal use of the received content data at the user side (refer, for example, to Document 1).

Document 1: Japanese Unexamined Patent Publication No 2002-314533

The streaming delivery technology requires that prescribed delivery quality be satisfied between the content delivery server and the user terminal, because the content data is not stored at the user terminal side.

However, the Internet is generally recognized as being a best-effort type network, so that the user has had to decide whether to purchase the content, that is, whether to pay for the content, when he or she does not know whether the service is really worth the payment from the viewpoint of delivery quality. This has been a major psychological barrier for the user when using such service.

### SUMMARY OF THE INVENTION

In view of the above problems, it is an object of the present invention to provide a content delivery system that properly bills the user according to the delivery quality of the service used. This properly billing mechanism not only serves to reduce the barrier for the user when using the service, but also serves to promote the use of the content delivery system.

According to the present invention, there is provided a content delivery system, for delivering content over a network, comprising: a subscriber serving apparatus serving a user; a delivery server for delivering content; and a billing server for billing for the delivery of the content, wherein the subscriber serving apparatus includes monitoring means for monitoring a data stream being delivered from the delivery server to the user, and the billing server includes judging means for judging whether to bill or not bill the user based on delivery quality of the monitored data stream, and bills the user based on the result of the judgment made by the judging means.

Further, according to the invention, the content delivery system further comprises a management apparatus for accepting a delivery request from the user, wherein the management apparatus includes means for identifying the subscriber serving apparatus serving the user that originated a delivery request, and for sending information specifying the user and the data stream to be monitored to the subscriber serving apparatus, and the subscriber serving apparatus, based on the information received from the management apparatus, identifies the user and the data stream to be monitored by the monitoring means.

Furthermore, according to the invention, the judging means includes a billing judgment table for setting a billing parameter, and determines the amount of billing to be charged to the user, based on the result of the judgment of the delivery quality of the monitored data stream and the billing parameter associated therewith.

### BRIEF DESCRIPTION OF THE INVENTION

The present invention will be more clearly understood from the description as set forth below with reference to the accompanying drawings, wherein:

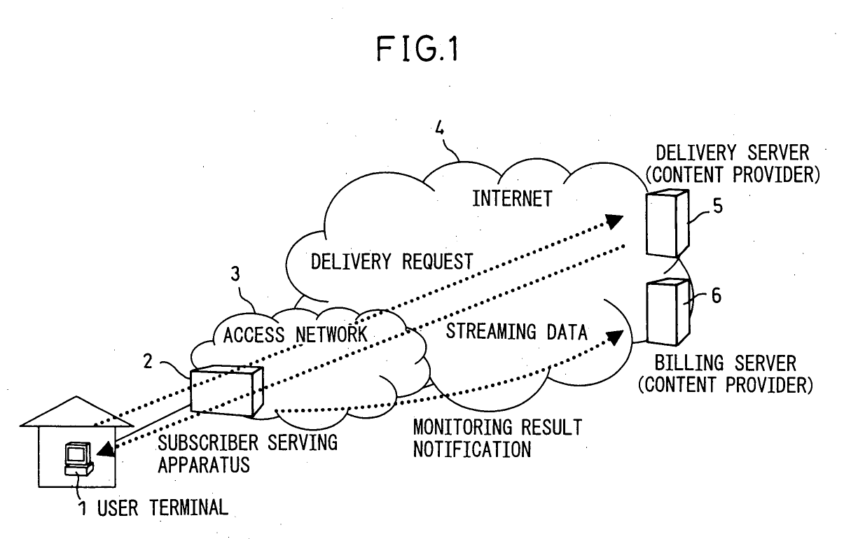

FIG. 1 is a diagram showing one configuration example of a content delivery system according to the present invention;

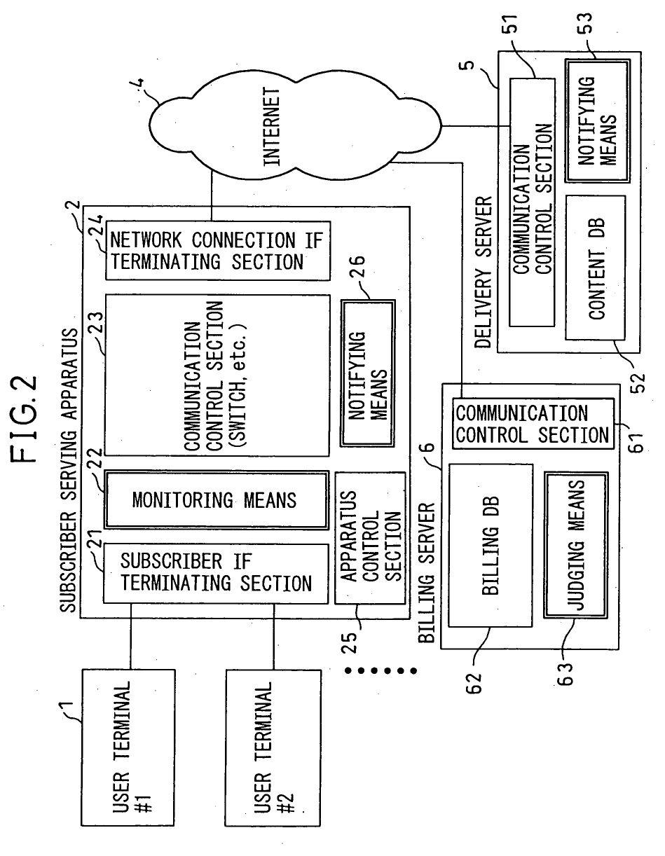

FIG. 2 is a diagram showing a first embodiment of a content delivery system according to the present invention;

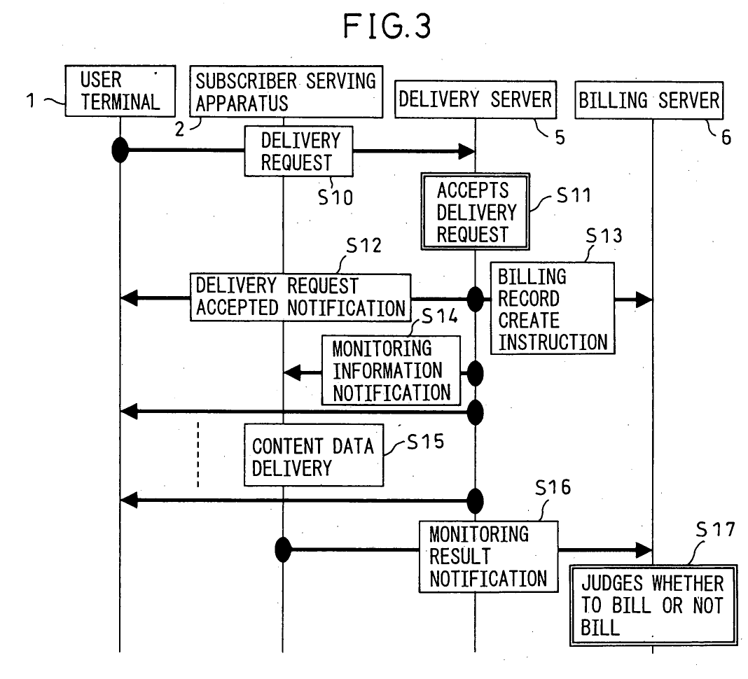

FIG. 3 is a diagram showing one example of a control message flow in the first embodiment;

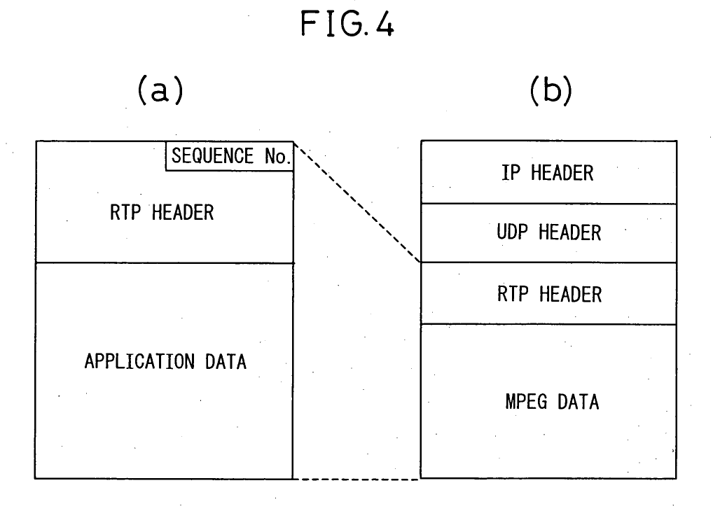

FIG. 4 is a diagram showing one example of a packet format of a data stream;

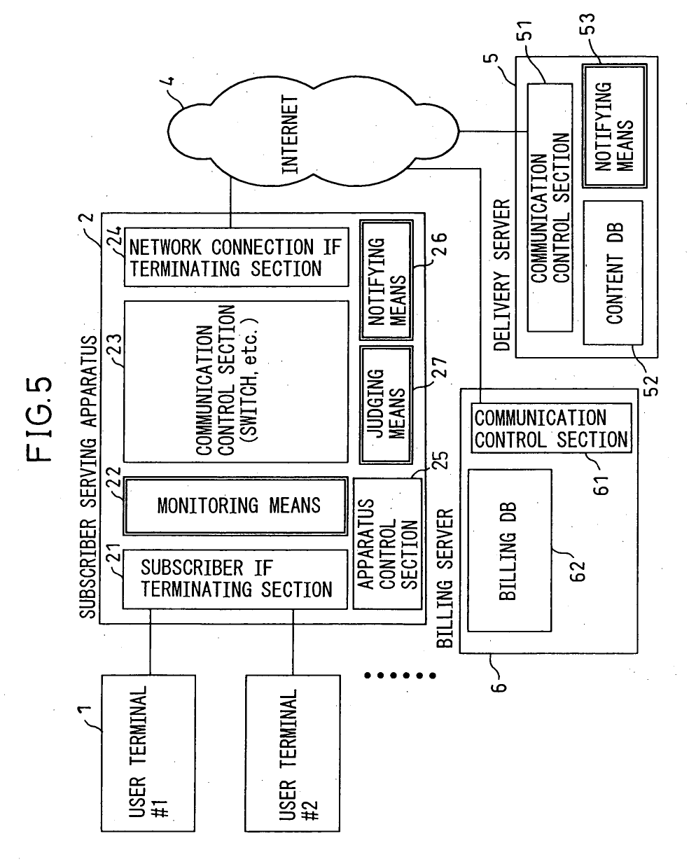

FIG. 5 is a diagram showing a second embodiment of a content delivery system according to the present invention;

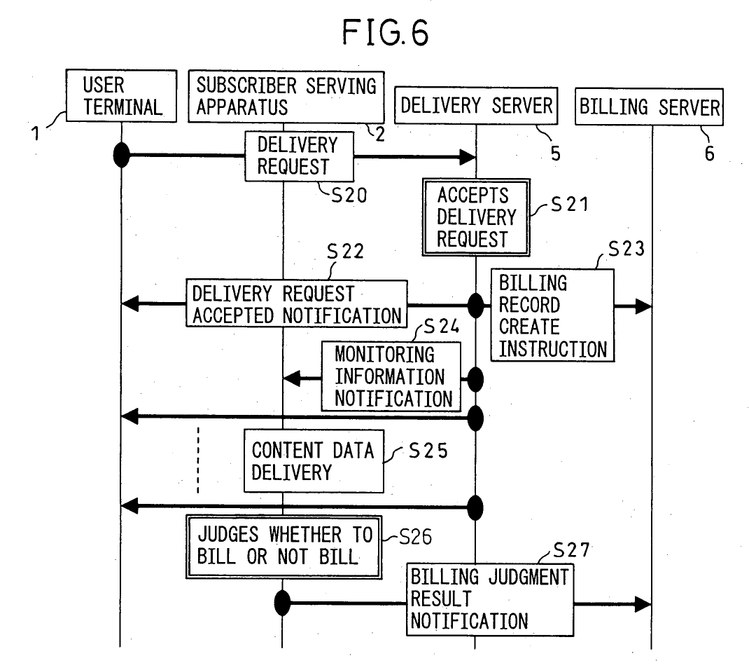

FIG. 6 is a diagram showing one example of a control message flow in the second embodiment;

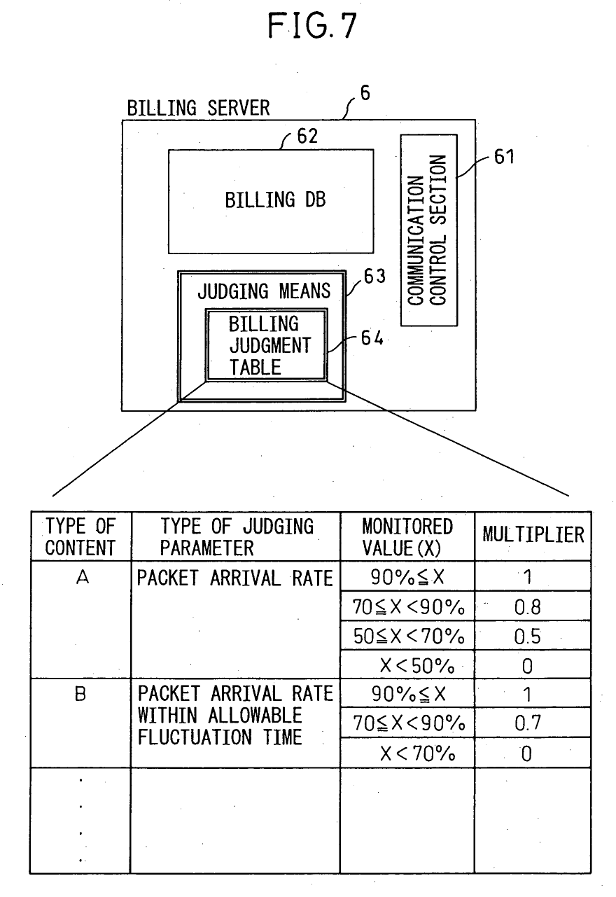

FIG. 7 is a diagram showing a third embodiment of a content delivery system according to the present invention;

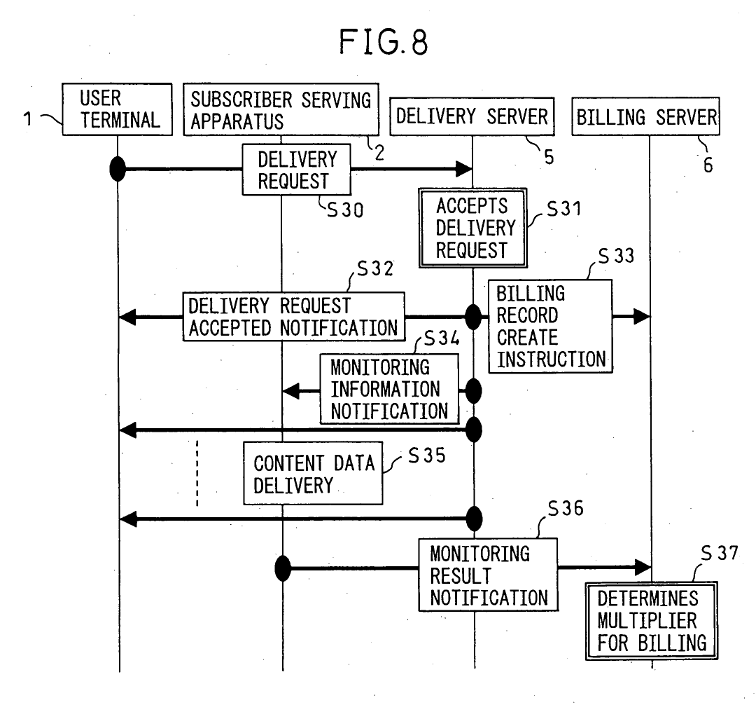

FIG. 8 is a diagram showing one example of a control message flow in the third embodiment;

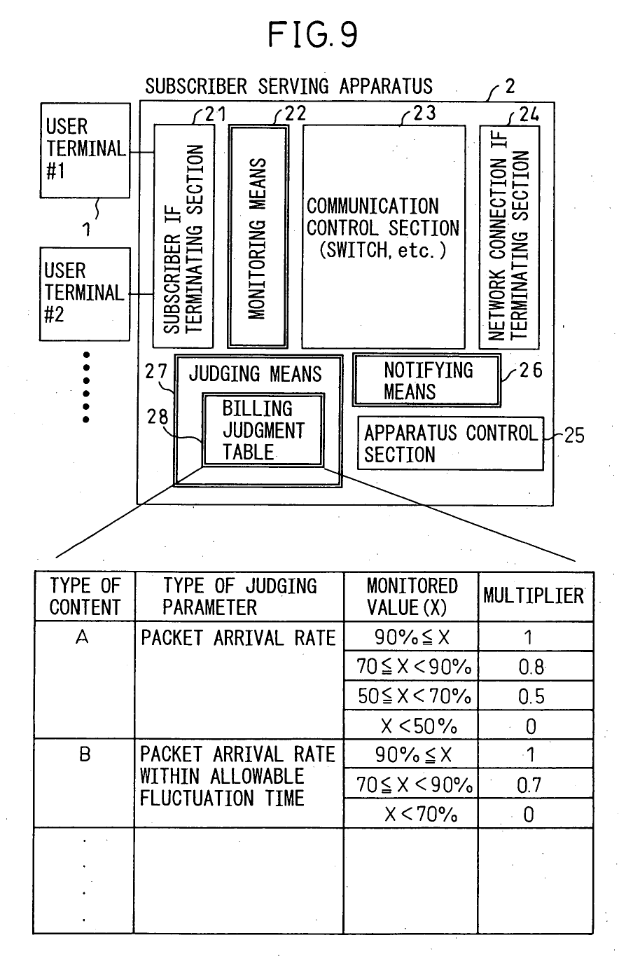

FIG. 9 is a diagram showing a fourth embodiment of a content delivery system according to the present invention;

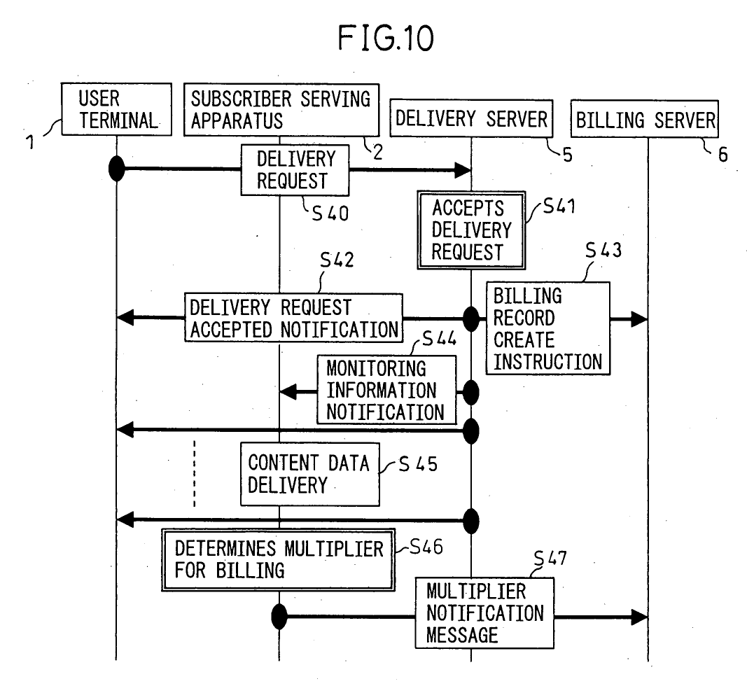

FIG. 10 is a diagram showing one example of a control message flow in the fourth embodiment;

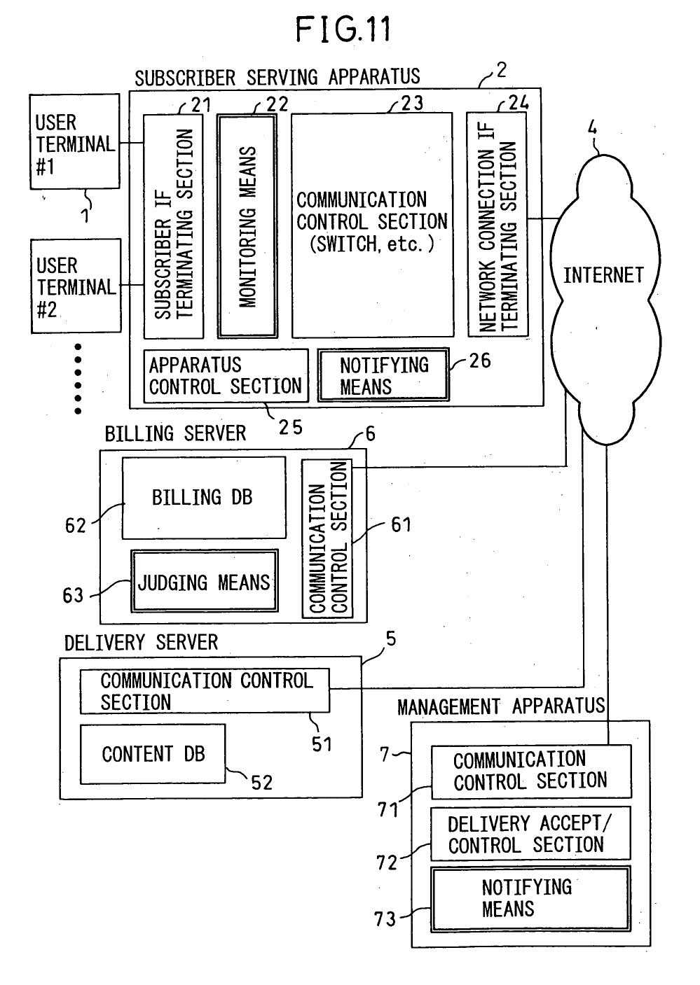

FIG. 11 is a diagram showing a fifth embodiment of a content delivery system according to the present invention; and

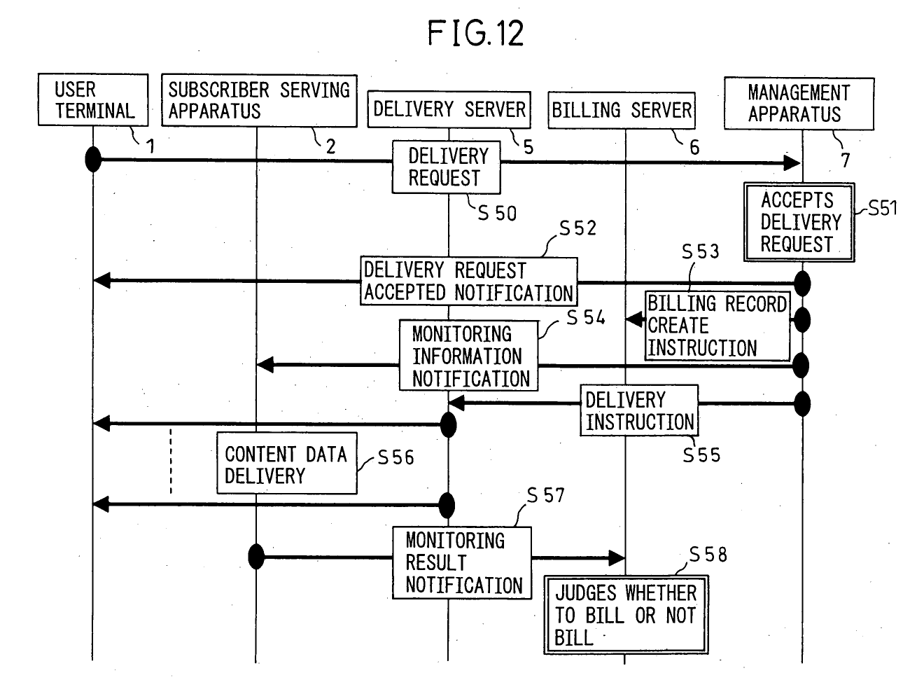

FIG. 12 is a diagram showing one example of a control message flow in the fifth embodiment.

### DESCRIPTION OF THE PREFERRED EMBODIMENTS

FIG. 1 is a diagram showing one configuration example of a network using a content delivery system according to the present invention.

In FIG. 1, the user requesting the delivery of his or her desired content first accesses an access network 3 from a user terminal 1. The access network 3 includes a subscriber serving apparatus 2 that serves the user terminal 1, and the user terminal 1 connects to a delivery server 5 on the Internet via the subscriber serving apparatus 2. At this time, the subscriber serving apparatus 2 monitors the delivery quality of the service being provided on a user-by-user basis, and sends billing information appropriate to the delivery quality to a billing server 6.

In the example shown, it is assumed that a high-speed line utilizing ADSL or an optical fiber cable is used between the user terminal 1 and the subscriber serving apparatus 2 and that, usually, congestion or packet discarding does not occur along the line. Accordingly, the subscriber serving apparatus 2 can accurately measure the delivery quality within the best-effort type network by just monitoring the delivery quality along the line between it and the user terminal 1. In the present invention, whether to bill or not bill the user for the service provided and the amount of billing, etc. are retroactively determined based on the monitoring information.

FIG. 2 is a diagram showing a first embodiment of a content delivery system according to the present invention. FIG. 3 is a diagram showing one example of a control message flow in the first embodiment. FIG. 4 is a diagram showing one example of a packet format of a data stream used to deliver content.

In FIG. 2, the subscriber serving apparatus 2 comprises a subscriber IF terminating section 21 which interfaces with the user terminal 1 at the subscriber side, a network connection IF terminating section 24 which interfaces with the Internet 4, etc., at the network side, a communication control section 23 which controls packet communications between the subscriber side and the network side, and an apparatus control section 25 which controls the entire operation of the subscriber serving apparatus; the subscriber serving apparatus 2 further comprises a monitoring means 22 for monitoring the delivery quality of content data transferred between the subscriber IF terminating section 21 and the communication control section 23, and a notifying means 26 for notifying the billing server 6 of the result of the monitoring.

The delivery server 5 comprises a communication control section 51 which interfaces with the Internet 4, etc., on the network side and controls packet communications, and a content database 52 which stores content data; the delivery server 5 further comprises a notifying means 53 for identifying the subscriber serving apparatus 2 serving the user who requested delivery of content, and for sending information specifying the user and the data stream to be monitored to the subscriber serving apparatus.

The billing server 6 comprises a communication control section 61 Which interfaces with the Internet 4, etc., on the network side and controls packet communications, and a billing database 62 which stores billing data on a user-by-user basis; the billing server 6 further comprises a judging means 62 for judging, based on the result of the monitoring from the subscriber serving apparatus 2, the billing conditions for the user to whom the service is provided.

In FIG. 2, the delivery server 5 and the billing server 6 are constructed as separate pieces of hardware, but they may be implemented as daemon applications which operate a plurality of servers within the same hardware. This also applies to the embodiments hereinafter given.

In the operation example of FIG. 3, first the user terminal 1 sends a delivery request for user-desired content to the delivery server 5 via the subscriber serving apparatus 2 (S10). The delivery server 5 processes the request to determine whether the requested content can be delivered or not (S11); if it is determined that the request is acceptable, the delivery server 5 transmits a request accepted notification message to the requesting user terminal 1, notifying it that the delivery request has been accepted (S12), and also transmits a billing record create instruction message to the billing server 6, instructing it to create a billing record (S13). Here, the transmission order of the request accepted notification message and the billing record create instruction message may be interchanged.

Next, the delivery server 5 transmits to the subscriber serving apparatus 2 a monitoring information notification message carrying the following information 1) to 4) (S14). That is, 1) user identifying information, such as the IP address of the user terminal 1 whose delivery request has been accepted, 2) data stream identifying information, such as the IP address of the delivery server 5 that transmits the data stream to be monitored, protocol identifier contained in the IP header, and port number contained in the UDP header, etc., 3) quality parameter information, such as a quality parameter to be reported to the billing server 6, for example, packet arrival rate, etc., and 4) billing server identifying information, such as the IP address of the billing server 6 to which the result of the monitoring is to be reported. After that, the delivery of the content data is initiated by the delivery server 5 (S15).

FIG. 4 shows one example of the packet format when RTP (Real Time Protocol) is used for the data stream to delivery the content. RTP is an application protocol used to transport real time traffic such as voice and moving images, and UDP/IP is used in its lower layer, as shown in a portion (b) of FIG. 4. MPEG data, in the case of moving images, and PCMA data, in the case of voice, for example, are used as application data. Further, the RTP header contains a field in which transmission sequence number is inserted, as shown in a portion (a) of FIG. 4. Therefore, packets missing, packet arrival rate, etc., can be determined by monitoring the sequence number.

Turning back to FIG. 3, when the subscriber serving apparatus 2 receives the monitoring information notification message (S14), its monitoring means 22 starts monitoring the specified user, the specified content data, and the specified quality parameter (packet arrival rate, etc.) based on the contents of the received information 1) to 4) described above. When the delivery of the content data is completed, the result of the monitoring is reported to the billing server 6 specified in the information 4) (S16). When the billing server 6 receives the monitoring result notification message, its judging means 63 judges whether to bill or not bill the user (S17).

In this way, according to the first embodiment, when packet missing, etc., occurs during the delivery of the content data to the user terminal 1, a monitoring result indicating the packet arrival rate lower than 100% is reported from the subscriber serving apparatus 2 to the billing server 6 which, based on the reported result, determines retroactively whether to bill or not bill the user. The user is thus assured that, if the desired delivery quality is not satisfied, the user will not be billed for the provided service. This alleviates the psychological barrier to using chargeable content, and serves to expand opportunities to use a content delivery business.

FIG. 5 is a diagram showing a second embodiment of a content delivery system according to the present invention. FIG. 6 is a diagram showing one example of a control message flow in the second embodiment.

The subscriber serving apparatus 2 in FIG. 5 contains a judging means 27 that has a function equivalent to that of the judging means 63 in the billing server 6 in the first embodiment. Therefore, the judging means 63 in the billing server 6 is not needed, and is thus omitted in this embodiment. Otherwise, the configuration is the same as that of the first embodiment, and the description will not be repeated here.

In FIG. 6, the flow from stops S20 to 25 is the same as the flow from steps S10 to 15 in FIG. 3. In step S26, the subscriber serving apparatus 2, using its judging means 27, judges whether to bill or not bill the user. The result of the judgment is reported to the billing server 6 by means of a billing judgment result notification message (S27).

In this way, according to the second embodiment, as the subscriber serving apparatus itself includes the means for determining whether to bill or not bill the user, even when the content provider coincides, for example, with the provider that provides the Internet access service, it becomes possible to distribute the processing for judging whether to bill or not bill the user served by the subscriber serving apparatus 2; this serves to alleviate the processing load on the billing server 6.

FIG. 7 is a diagram showing a third embodiment of a content delivery system according to the present invention. FIG. 8 is a diagram showing one example of a control message flow in the third embodiment.

In FIG. 7, the billing server 6 contains the judging means 63 as in the case of the billing server of the first embodiment, but the difference is that the judging means 63 includes a billing judgment table 64. The billing server 6 of this embodiment does not simply judge whether to bill or not bill the user as in the first embodiment but, as shown in FIG. 8, determines the multiplier by which to multiply the fee to be charged to the user (S37), by using the billing judgment table 64 based on the monitoring result reported by means of the monitoring result notification message (S36).

That is, by using the preset billing judgment table 64, the multiplier that matches the reported monitoring result is selected from among a plurality of multipliers, and the fee is multiplied by the multiplier to determine the fee to be charged according to the quality of the delivered content.

In FIG. 7, a judging parameter “packet arrival rate” is applied to content A containing, for example, moving images, etc. Here, if the packet arrival rate carried in the monitoring result notification message (S37) is 98%, the multiplier “1” is applied to the normal fee. If the packet arrival rate is 80%, the multiplier “0.8” is applied to the normal fee (S37).

Similarly, a judging parameter “allowable fluctuation time” is applied to content B containing, for example, voice, etc. Here, if the packet arrival rate within that time is 50%, the multiplier by which to multiply the normal fee is “0”, and it is determined that the user is not to be billed. In FIG. 8, steps other than steps S36 and 37, that is, steps S30 to 35, are the same as steps S10 to 15 in FIG. 3.

In this way, the content provider in this embodiment can offer a plurality of fee choices to the user, and can bill the user by multiplying the fee by the multiplier determined according to the viewing/listening quality. With the realization of such a proper billing system, the barrier to the use of content is further reduced, and opportunities to use a content delivery business are further expanded.

FIG. 9 is a diagram showing a fourth embodiment of a content delivery system according to the present invention. FIG. 10 is a diagram showing one example of a control message flow in the fourth embodiment.

This embodiment is equivalent to a combination of the second and third embodiments, and the judging means 27 provided in the subscriber serving apparatus 2 includes a billing judgment table 28. Using this billing judgment table 28, the multiplier that matches the monitoring result is selected from among a plurality of multipliers, and the fee is multiplied by the multiplier to determine the fee to be charged according to the quality of the delivered content.

When the multiplier is determined at the subscriber serving apparatus 2 side (S46), the determined multiplier is reported to the billing server 6 by means of a multiplier notification message (S47). The other steps S40 to 45 are the same as steps S10 to 15 in FIG. 3. In this way, according to the fourth embodiment, not only can the billing be achieved that is appropriate to the quality of the delivered content, but the billing processing load of the billing server 6 can also be alleviated.

FIG. 11 is a diagram showing a fifth embodiment of a content delivery system according to the present invention. FIG. 12 is a diagram showing one example of a control message flow in the fifth embodiment.

As shown in FIG. 11, in this embodiment, a management apparatus 7 is provided separately from the delivery server 5, and a delivery request from each user terminal 1 is accepted by the management apparatus 7.

The management apparatus 7 comprises a communication control section 71 which interfaces with the Internet 4, etc., on the network side and controls packet communications, a delivery accept/control section 72 which accepts a delivery request from the user terminal 1 and determines the delivery destination, and a notifying means 73 for notifying the delivery destination of necessary information. Accordingly, the notifying means 53 having an equivalent function is omitted from the delivery server 5. The following description is given based on the configuration of the first embodiment, while incorporating the above-described differences.

As shown in FIG. 12, first, the user terminal 1 sends a delivery request for user-desired content to the management apparatus 7 via the subscriber serving apparatus 2 (S50). The delivery accept/control section 72 of the management apparatus 7 processes the request to determine whether the requested content can be delivered or not (S51). If it is determined that the request is acceptable, the notifying means 73 transmits a request accepted notification message to the requesting user terminal 1, notifying it that the delivery request has been accepted (S52), and also transmits a billing record create instruction message to the billing server 6, instructing it to create a billing record (S53).

Next, the management apparatus 7 sends a monitoring information notification message, which carries the previously described information 1) to 4), to the specified subscriber serving apparatus 2 (S54). In this embodiment, the management apparatus 7 also sends a delivery instruction message to the delivery server 5 (S55). After that, the delivery of the content data is initiated by the delivery server 5 (S15), and the same processing as that explained in the first embodiment is performed (S57 and 58).

In this way, according to this embodiment, of the processing to be performed at the delivery server 5 that actually delivers data, the processing for accepting the delivery request, the processing for specifying the data flow to be monitored by the subscriber serving apparatus 2, and other related processing are performed centrally at the management apparatus 7. This serves to further enhance the scalability of the content delivery system.

Further, when the management apparatus 7 is provided with an HTTP server function, the user terminal 1 using an ordinary browser can access the management apparatus 7 in a common way. In this case, other communication protocols (for example, SNMP) can be used as appropriate for communications between the management apparatus 7 and other subscriber serving apparatus 2, delivery server 5, and billing server 6, and the management of the entire system becomes efficient and easy.

As described above, according to the present invention, when image disturbances or instantaneous breaks in the data stream occur during the playing of the user-requested content, a properly adjusted fee is billed to the user; accordingly, the user can use the content delivery service without any worries and, also, the content delivery service business can be expanded.

1. A content delivery system for delivering content over a network, comprising:
a subscriber serving apparatus serving a user;
a delivery server for delivering content; and
a billing server for billing for the delivery of the content, wherein
the subscriber serving apparatus includes monitoring means for monitoring a data stream being delivered from the delivery server to the user, and
the billing server includes judging means for judging whether to bill or not bill the user based on delivery quality of the monitored data stream, and bills the user based on the result of the judgment made by the judging means.

2. A content delivery system for delivering content over a network, comprising;
a subscriber serving apparatus serving a user;
a delivery server for delivering content: and
a billing server for billing for the delivery of the content, where
the subscriber serving apparatus includes monitoring means for monitoring a data stream being delivered from the delivery server to the user, and judging means for judging whether to bill or not bill the user based on delivery quality of the monitored data stream, and
the billing server bills the user based on the result of the judgment made by the judging means.

3. A content delivery system as claimed in claim 1, wherein
the delivery server includes means for identifying the subscriber serving apparatus serving the user that originated a delivery request, and for sending information specifying the user and the data stream to be monitored to the subscriber serving apparatus, and
the subscriber serving apparatus, based on the information received from the delivery server, identifies the user and the data stream to be monitored by the monitoring means.

4. A content delivery system as claimed in claim 1, further comprising a management apparatus for accepting a delivery request from the user, wherein
the management apparatus includes means for identifying the subscriber serving apparatus serving the user that originated the delivery request, and for sending' information specifying the user and the data stream to be monitored to the subscriber serving apparatus, and
the subscriber serving apparatus, based on the information received from the management apparatus, identifies the user and the data stream to be monitored by the monitoring means.

5. A content delivery system as claimed in claim 1 wherein the judging means includes a billing judgment table for setting billing parameter, and determines the amount of billing to be charged to the user, based on the result of the judgment of the delivery quality of the monitored data stream and the billing Remarks
